(19) United States
(12) Patent Application Publication
(10) Pub. No.: US 2020/0167093 A1
(43) Pub. Date: May 28, 2020

(54) STORAGE VIRTUALIZATION WITH HIGH AVAILABILITY

(71) Applicant: International Business Machines Corporation, Armonk, NY (US)

(72) Inventors: Long Wen Lan, Shanghai (CN); Henry E. Butterworth, Shanghai (CN)

(21) Appl. No.: 16/200,990

(22) Filed: Nov. 27, 2018

(51) Int. Cl. G06F 3/06

(52) U.S. Cl. CPC G06F 3/0647; G06F 3/0604; G06F 3/067; G06F 3/0664; G06F 3/064

(57) ABSTRACT

A computer-implemented method, apparatus, and computer program product implemented in a storage system are disclosed. The storage system comprises a plurality of virtual storage nodes and a plurality of block storages. Each of the block storages is attached to a single virtual storage node. One or more processors receive an availability for the plurality of virtual storage nodes from at least one virtual storage node. In response to receiving the availability for the plurality of virtual storage nodes, the one or more processors determine one or more virtual storage nodes are unavailable. In response to determining one or more virtual storage nodes are unavailable, the one or more processors cause a representative node of the plurality of virtual storage nodes to redistribute one or more block storages attached to one or more unavailable virtual storage nodes to one or more available virtual storage nodes.

### BACKGROUND

The present disclosure relates generally to storage technology, and more specifically, to a computer-implemented method, apparatus, and computer program product for storage virtualization with high availability.

Generally, storage systems may provide object storage, block storage, and file storage. In some storage systems, physical storages are virtualized to implement block storage. For example, in a storage system such as a public cloud storage system, each of the block storages may be typically attached to a single virtual machine through a hypervisor. The virtual machine can take the attached block storages as its local disks. This allows only one block storage to be available to a single virtual machine at any given time, preventing multiple virtual machines from sharing a single block storage. In addition, data stored in a block storage attached to one virtual machine may have two or more copies in other block storages attached to other virtual machines in the storage system to survive single copy failure.

### SUMMARY

According to one embodiment of the present disclosure, there is provided a method implemented in a storage system. The storage system comprises a plurality of virtual storage nodes and a plurality of block storages. Each of the block storages is attached to a single virtual storage node. One or more processors receive an availability for the plurality of virtual storage nodes from at least one virtual storage node. In response to receiving the availability for the plurality of virtual storage nodes, the one or more processors determine one or more virtual storage nodes are unavailable. In response to determining one or more virtual storage nodes are unavailable, the one or more processors cause a representative node of the plurality of virtual storage nodes to redistribute one or more block storages attached to one or more unavailable virtual storage nodes to one or more available virtual storage nodes.

According to another embodiment of the present disclosure, there is provided a storage system. The storage system comprises a plurality of virtual storage nodes and a plurality of block storages. Each of the block storages is attached to a single virtual storage node. The storage system further comprises one or more processors, a memory coupled to the one or more processors, and a set of computer program instructions stored in the memory and executed by the one or more processors to implement the method according to the one embodiment of the present disclosure as described above.

According to still another embodiment of the present disclosure, there is provided a computer program product implemented in a storage system. The storage system comprising a plurality of virtual storage nodes and a plurality of block storages. Each of the block storages is attached to a single virtual storage node. The computer program product comprises a computer readable storage medium having program instructions embodied therewith. The program instructions are executable by a processor to implement the method according to the one embodiment of the present disclosure as described above.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 illustrates an exemplary diagram of a storage system, in accordance with embodiments of the present disclosure.

FIG. 5 illustrates a flow diagram of an example process for storage virtualization with high availability, in accordance with embodiments of the present disclosure.

FIG. 6 illustrates a flow diagram of an example process for redistributing the block storages, in accordance with embodiments of the present disclosure.

FIG. 7 illustrates a flow diagram of an example process for storage virtualization with high availability, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to the field of storage technology, and more particularly to a computer-implemented method, apparatus, and computer program product for storage virtualization with high availability. While the present disclosure is not necessarily limited to such applications, various aspects of the disclosure may be appreciated through a discussion of various examples using this context.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

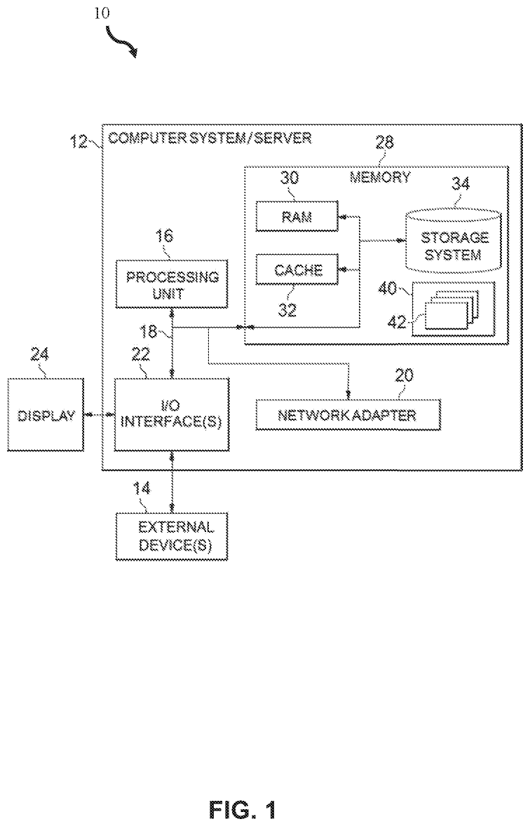

Referring now to FIG. 1, shown is an example cloud computing node 10, in accordance with embodiments of the present disclosure. Cloud computing node 10 is only one example of a suitable cloud computing node and is not intended to suggest any limitation as to the scope of use or functionality of embodiments of the disclosure described herein. Cloud computing node 10 is capable of being implemented and/or performing any of the functionality set forth hereinabove.

Cloud computing node 10 includes a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 of cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. For example, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

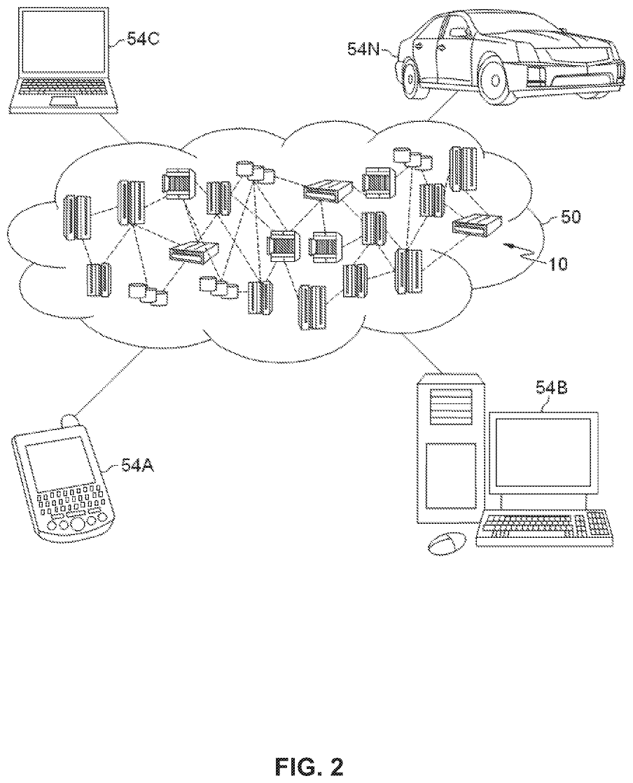

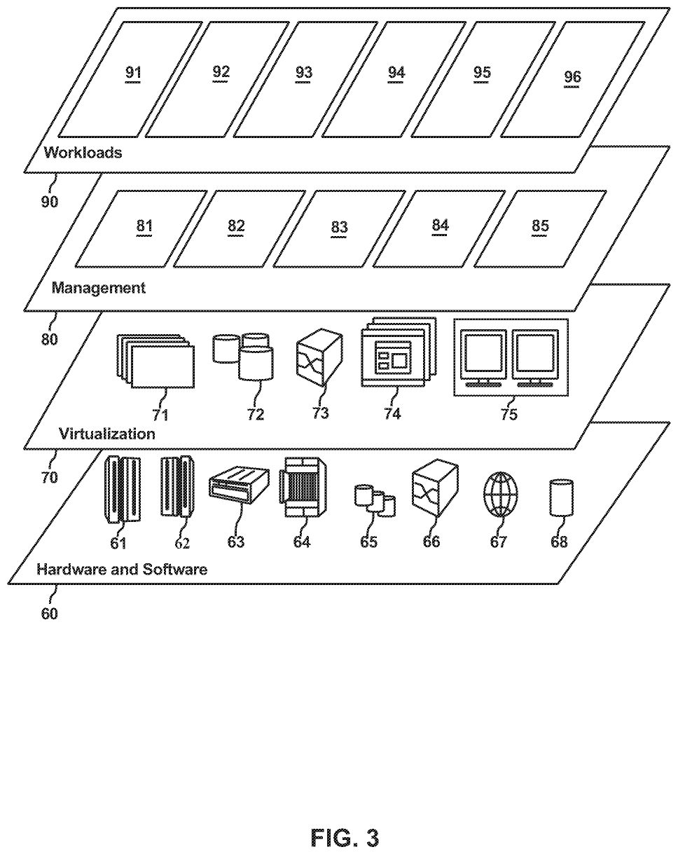

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Computer system/server 12 can communicate with one or more networks such as a local area network (LAN), a general wide area network (WAN), and/or a public network (e.g., the Internet) via network adapter 20. Computer system/server 12 may communicate with cloud computing environment 50 as described in FIG. 2 and FIG. 3. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and storage virtualization 96.

It is noted that, in addition to the cloud system described above, embodiments of the present disclosure can be implemented in any computer and network systems. Also the present disclosure is not limited to the computer system described above, for example, with reference to FIG. 1.

In the storage system, the virtual machines and the block storages attached to these virtual machines are transparent to an application client. The application client may access the storage system without knowing the configuration of the virtual machines and block storages. Therefore, an advanced storage management software running on the virtual machines can provide advanced storage capabilities to the application client, such as fast write cache, and RAID 0 (striping) across multiple block storages.

As described above, one block storage can only be attached to a single virtual machine in certain storage system, such as a public cloud storage system. Therefore, when one virtual machine of the storage system fails, the block storage(s) attached to the virtual machine cannot be accessed by any application client. Thus, the storage system will be out of service. Such single-point-of-failure may happen for the following reasons: reboot of the virtual machine, or software upgrade for the virtual machine, or software failure of the virtual machine, or power failure of the virtual machine or hypervisor failure of the virtual machine. Currently there are several methods to solve the single-point-of-failure, such as Redundant Arrays of Independent Disks (RAID) and erasure code. Typically, the data stored in the block storage(s) of each virtual machine are duplicated in other block storage(s) of other virtual machines. When the virtual machine failed, the data can be recovered from redundant copies on the surviving virtual machines. Therefore, current solutions of the single-point-of-failure have low storage efficiency. Since most of data stored in the block storages of the storage system is backup data, the storage utility of the storage system is affected. In fact, the block storages in the storage system actually already have been built with certain level of redundancy, the storage utility of the storage system is further affected.

Embodiments of the present disclosure provide a scheme of storage virtualization with high availability, which can improve the storage efficiency of the storage system.

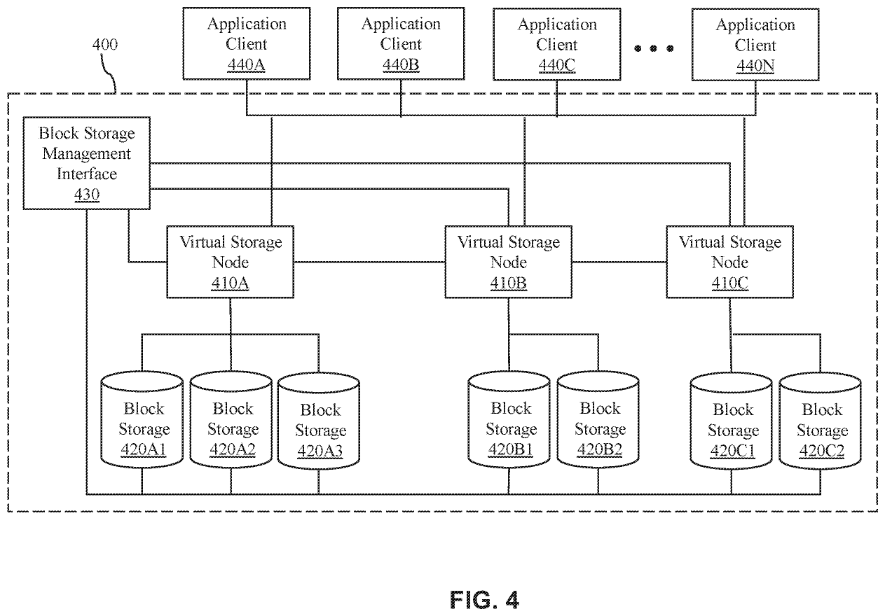

With reference now to FIG. 4, shown is an exemplary diagram of a storage system 400, in accordance with embodiments of the present disclosure. The storage system 400 comprises a plurality of virtual storage nodes 410A, 410B, 410C (collectively referred to as virtual storage node 410), a plurality of block storages 420A1, 420A2, 420A3, 420B1, 420B2, 420C1, 420C2 (collectively referred to as block storages 420), and a block storage management interface 430. In this example, the virtual storage nodes 410 are in the form of virtual machines and may be hosted in the computer system/server 12 as shown in FIG. 1.

As shown in FIG. 4, each virtual storage node 410 may be attached with one or more block storages 420. In the illustrative embodiment, a first virtual storage node 410A may be attached with three block storages, i.e., block storage 420A1, block storage 420A2, and block storage 420A3. A second virtual storage node 410B may be attached with two block storages, i.e., block storage 420B1 and block storage 420B2. A third virtual storage node 410C may be attached with two block storages, i.e., block storage 420C1 and block storage 420C2. A plurality of application clients 440A, 440B, 440C, 440N (collectively referred to as application clients 440) may access the storage system 400 through the virtual storage nodes 410.

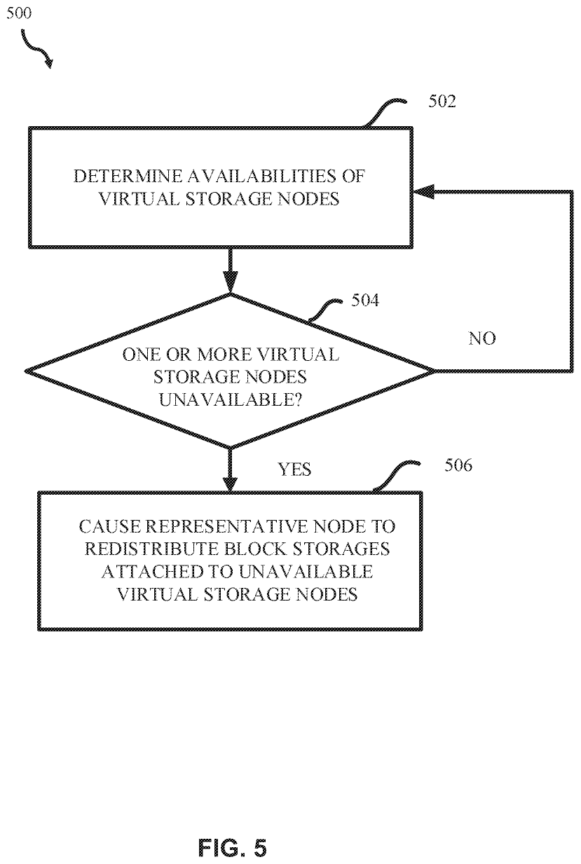

With reference now to FIG. 5, shown is a flow diagram of an example process 500 for storage virtualization with high availability, in accordance with embodiments of the present disclosure. The process 500 may be implemented in the storage system 400 as shown in FIG. 4.

In some embodiments, the process 500 begins by one or more processors of the storage system determining the availability of the plurality of virtual storage nodes (e.g., 410A, 410B, 410C). This is illustrated in step 502. The availability of the plurality of virtual storage nodes is based on results of detecting availabilities of the plurality of virtual storage nodes from at least one of the plurality of virtual storage nodes. The results of detecting availabilities of the plurality of virtual storage nodes may be sent from at least one virtual storage node.

For example, a virtual storage node of the plurality of virtual storage nodes may detect availabilities of other virtual storage nodes and send the detected result to the one or more processors. In another example, each of a part of the virtual storage nodes may detect availabilities of other virtual storage nodes and send the detected result to the one or more processors. In yet another example, each of the plurality of virtual storage nodes may detect availabilities of other virtual storage nodes and send the detected result to the one or more processors. In the following, each virtual storage node detecting availabilities of other virtual storage nodes is taken as an example to describe the process of detecting availabilities.

In some embodiments, each of the virtual storage nodes may send a detection message to other virtual storage nodes. For example, the second virtual storage node 410B may send the detection message to the first virtual storage node 410A and the third virtual storage node 410C. If the second virtual storage node 410B receives a detection response from the first virtual storage node 410A, the second virtual storage node 410B may determine that the first virtual storage node 410A is available. If the second virtual storage node 410B receives no response from the third virtual storage node 410C, the second virtual storage node 410B may determine that the third virtual storage node 410C is unavailable. Similarly, the first virtual storage node 410A and the third virtual storage node 410C may detect the availability of other virtual storage nodes respectively. Once the availability of the nodes is determined, each of the virtual storage nodes may send the result of detecting availabilities of the respective virtual storage nodes to the one or more processors.

In some embodiments, each of the virtual storage nodes may send reporting messages to the other virtual storage nodes at regular time intervals, such that the availability of all the virtual storage nodes may be determined. In the exemplary storage system as shown in FIG. 4, for example, the first virtual storage node 410A may send reporting messages to the second virtual storage node 410B and the third virtual storage node 410C, respectively. If the second virtual storage node 410B receives no reporting messages from the first virtual storage node 410A during a predetermined period, the second virtual storage node 410B may determine that the first virtual storage node 410A is unavailable. If the third virtual storage node 410C receives reporting messages from the first virtual storage node 410A at regular time intervals, the third virtual storage node 410C may determine that the first virtual storage node 410A is available. Similarly, the second virtual storage node 410B and the third virtual storage node 410C may send reporting messages to the other virtual storage nodes at regular time intervals, respectively. In this way, each of the virtual storage nodes may detect availabilities of the other virtual storage nodes based on the reporting messages. Then, each of the virtual storage nodes may send the result of detecting availabilities of the respective virtual storage nodes to the one or more processors.

One virtual storage node may be determined as available when any one of the other virtual storage nodes determines that it is available. One virtual storage node may be determined as unavailable when none of the other virtual storage nodes determine that it is available. For example, if the first virtual storage node 410A cannot communicate with the second virtual storage node 410B, the first virtual storage node 410A may determine that the second virtual storage node 410B is unavailable. If the third virtual storage node 410C can communicate with the second virtual storage node 410B, the third virtual storage node 410C may determine that the second virtual storage node 410B is available. In this case, the second virtual storage node 410B may be determined as available since it can access the storage system through the third virtual storage node 410C. The one or more processors may inform the plurality of virtual storage nodes 410A, 410B, 410C of the availabilities of each virtual storage node. Thus, all the virtual storage nodes 410A, 410B, 410C can determine which virtual storage node is unavailable.

If it is determined that one or more virtual storage nodes are unavailable (illustrated at step 504), the one or more processors may cause (e.g., instruct) a representative node of the plurality of virtual storage nodes 410A, 410B, 410C to redistribute one or more block storages attached to the one or more unavailable virtual storage nodes to one or more available virtual storage nodes. This is illustrated at step 506. The representative node may be selected during the process of initializing the storage system. In some embodiments, the representative node may be selected based on a workload of the virtual storage nodes. For example, the virtual storage node having the lowest workload may be selected as the representative node. When the representative node is unavailable, a new representative node may be selected. If all the virtual storage nodes are determined to be available, the one or more processors will continue to monitor the availability of the plurality of virtual storage node (e.g., monitoring the results of availability from the virtual storage nodes at regular time intervals to determine availability).

The plurality of virtual storage nodes may be configured with address information of the plurality of block storages and meta information. The address information indicates a logical address space corresponding to the respective block storage. The meta information indicates an attachment relationship of the respective block storages and the respective virtual storage nodes. Each of the first, second and third virtual storage nodes may report its block storage attachment to other virtual storage nodes and/or to the block storage management interface 430 (as shown in FIG. 4). When a new virtual storage node is joined in the storage system, one of the first, second and the third virtual storage nodes may redistribute one or more block storages to the newly joined virtual storage node. In some embodiments, the block storage management interface 430 may be included in one or more of the virtual nodes 410.

In an embodiment, each of the virtual storage nodes may exchange its block storage attachment and address information with each other. In another embodiment, each of the virtual storage nodes may send its block storage attachment and address information to the block storage management interface. The block storage management interface may then forward the block storage attachment and address information from each of the virtual storage nodes to other virtual storage nodes. Thus, each virtual storage node may have information about the attachments of all the block storages to the respective virtual storage nodes. This information may be referred to as “meta information” hereinafter. A plurality of application clients 440 may access the storage system 400 through the virtual storage nodes. Moreover, attachments of the block storages to the virtual storage nodes may be managed via the block storage management interface 430. For example, the block storage may be detached or attached to the virtual storage node via the block storage management interface 430 in response to a request from the representative node.

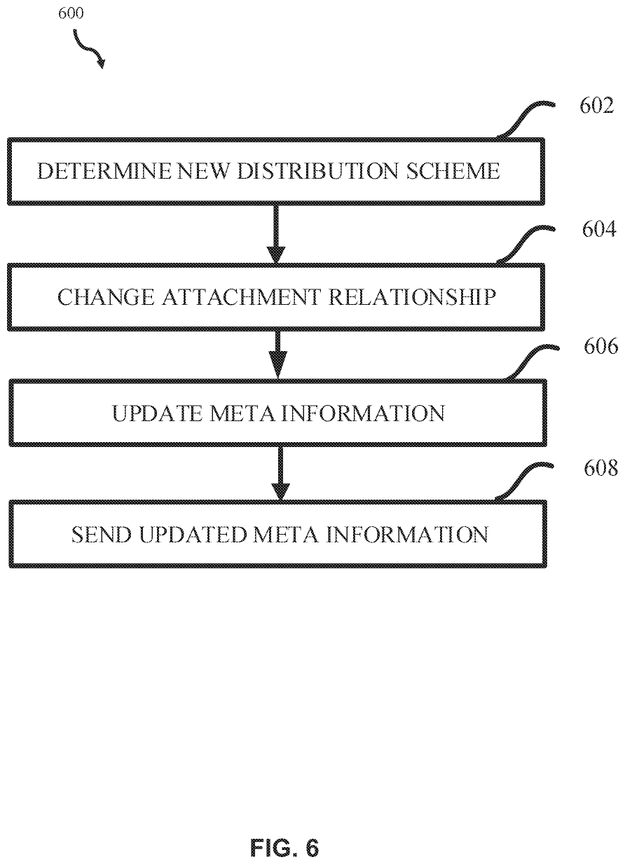

With reference now to FIG. 6, shown is a flow diagram of an example process 600 for redistributing the block storages, in accordance with embodiments of the present disclosure. The process 600 may be implemented in the storage system 400 as shown in FIG. 4. In some embodiments, the process 600 begins by the representative node determining a new distribution scheme for redistributing the one or more block storages attached to the one or more unavailable virtual storage nodes to the one or more available virtual storage nodes based on the meta information. This is illustrated in step 602.

In the above example, it is assumed that the second virtual storage node 410B is the representative node, and the third virtual storage node 410C is the unavailable storage node. The unavailable storage node has two block storages 420C1, 420C2 attached. In some embodiments, the new distribution scheme may be determined based on load balance. In an embodiment, the representative node may determine the workload of each of the available virtual storage node. For example, the workload may be represented by the number of the block storages attached to the virtual storage node. In the above example, the first virtual storage node 410A has three block storages attached, and the second virtual storage node 410B has two block storages attached. As the workload of the second virtual storage node 410B is lower than that of the first virtual storage node 410A, the representative node (i.e. the second virtual storage node 410B) may determine that the two block storages attached to the unavailable virtual storage node are redistributed to the second virtual storage node 410B. Alternatively, the representative node may determine that one block storage attached to the unavailable virtual storage node is redistributed to the first virtual storage node 410A and the other block storage is redistributed to the second virtual storage node 410B.

The process 600 continues by the representative node changing the attachment relationship of the one or more block storages attached to the one or more unavailable virtual storages according to the new distribution scheme via the block storage management interface 430. This is illustrated in step 604. In an embodiment, the representative node may make a request for changing attachment relationship of the block storage(s) attached to the unavailable virtual storage node(s) according to the new distribution scheme. The request may be sent via the block storage management interface 430 in FIG. 4. Then the block storage(s) may be detached from the unavailable virtual storage node(s) and be reattached to one or more available virtual storage nodes according to the new distribution scheme via the block storage management interface 430. In the above example, the two block storages 420C1, 420C2 may be detached from the third virtual storage node 410C via the block storage management interface 430. Then the two block storages 420C1, 420C2 may be reattached to the second virtual storage node 410B via the block storage management interface 430, or one block storage 420C1 may be reattached to the first virtual storage node 410A and the other block storage 420C2 may be reattached to the second virtual storage node 410B via the block storage management interface 430. Then the successful attachment relationship change may be informed to the representative node via the block storage management interface 430 if the new redistribution scheme is accepted.

The process 600 continues by the representative node updating the meta information according to the changed attachment relationship. This is illustrated in step 606. In the above example, the updated meta information may indicate that three block storages 420A1, 420A2 and 420A3 are attached to the first virtual storage node 410A, and four block storages 420B1, 420B2, 420C1, and 420C2 are attached to the second virtual storage node 410B.

The process 600 continues by the representative node sending the updated meta information to the other available virtual storage nodes. This is illustrated in step 608. The other available virtual storage nodes may update their meta information according to the received meta information. Thus, the first and second virtual storage nodes may use the update meta information to handle access request(s).

Additionally, in some embodiments, when one or more unavailable virtual storage nodes are recovered, the recovery may be informed to the representative node. Then one or more block storages attached to the available virtual storage nodes may be redistributed to the recovered one or more virtual storage nodes by the representative node. The redistribution of the block storages is similar to the above process as shown in FIG. 6. In the above example, when the third virtual storage node 410C is recovered, the second virtual storage node 410B may redistribute the block storages. For example, the second virtual storage node 410B may redistribute block storages 420B1 and 420C1 attached to the second virtual storage node 410B to the third virtual storage node 410C to balance the workloads of the virtual storage nodes. Then the second virtual storage node 410B may request for changing the attachment relationship of the block storages to the virtual storage nodes via the block storage management interface 430. The block storages 420B1 and 420C1 may be detached from the second virtual storage node 410B and reattached to the third virtual storage node 410C via the block storage management interface 430. Then the second virtual storage node 410B may be informed of the successful change via the block storage management interface 430. Then the second virtual storage node 410B may update its meta information and send the updated meta information to the first and third virtual storage nodes 410A and 410C, respectively. Thus, all the virtual storage nodes have the updated meta information. Now the update meta information indicates that that three block storages 420A1, 420A2, and 420A3 are attached to the first virtual storage node 410A, two block storages 420B2, 420C2 are attached to the second virtual storage node 410B, and two block storages 420B1, 420C1 are attached to the third virtual storage node 410C.

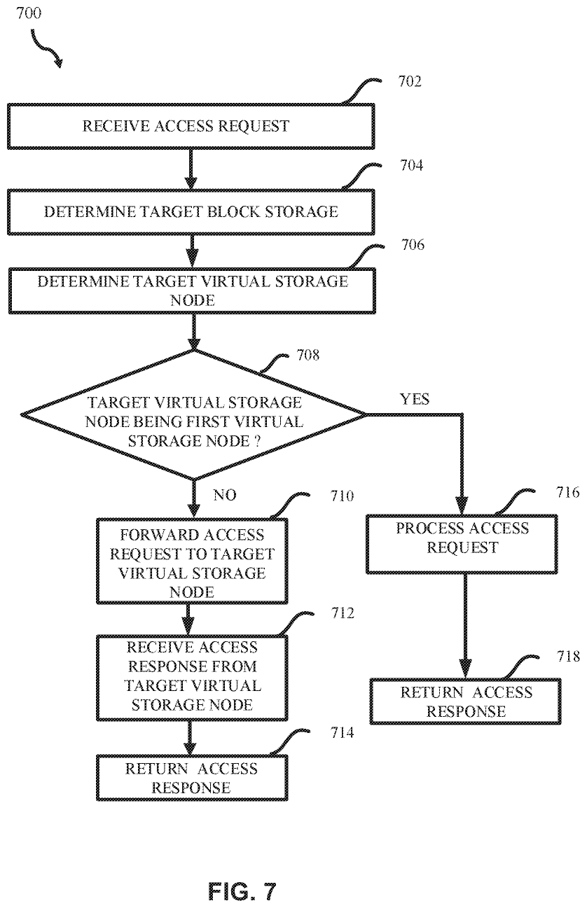

With reference now to FIG. 7, shown is a flow diagram of an example process 700 for storage virtualization with high availability, in accordance with embodiments of the present disclosure. The method 700 may be implemented in the storage system as shown in FIG. 4. In some embodiments, the process 600 begins by with a virtual storage node receiving an access request (e.g. the first virtual storage node 410A). This is illustrated at step 702. In this case, the first virtual storage node 410A may determine a target block storage based on the access request and the address information of the plurality of block storages. In some embodiments, the access request may comprise a destination address. The access request may be, for example, a read request for reading data from the destination address, or a write request for writing data into the destination address. In some embodiments, the access request may be received from an application client or another virtual storage node.

As described above, each of the virtual storage nodes may have the address information about the block storages of the storage system. Therefore, the first virtual storage node 410A may determine the block storage corresponding to the destination address as the target block storage.

The process 700 continues by the first virtual storage node 410A determining a target virtual storage node to which the target block storage is attached based on the meta information. This is illustrated at step 704. As each of the virtual storage nodes has the meta information about which virtual storage node the block storage is attached to, the first virtual storage node 410A may determine the target virtual storage node based on the meta information. In the storage system 400 as shown in FIG. 4, the meta information indicates that block storages 420A1, 420A2 and 420A3 are attached to the first virtual storage node 410A, block storages 420B1, 420B2 are attached to the second virtual storage node 410B, and block storages 420C1, 420C2 are attached to the third virtual storage node 410C.

The process 700 continues by the first virtual storage node 410A determining whether the target virtual storage node is the first virtual storage node 410A itself or not. This is illustrated in step 706. If the target virtual storage node is not the first virtual storage node 410A itself (“NO” illustrated in step 708) the first virtual storage node 410A may forward the access request to the target virtual storage node. This is illustrated in step 710. Upon receipt of the access request, the target virtual storage node may determine that the target block storage is attached to it, and then process the access request. Then the target virtual storage node may reply to the first virtual storage node 410A with an access response.

The first virtual storage node 410A may receive the access response from the target virtual storage node. This is illustrated in step 712. The first virtual storage node 410A may return the access response to the application client. This is illustrated at step 714.

Alternatively, if the first virtual storage node 410A determines that the target virtual storage node is the first virtual storage node 410A itself (“YES” illustrated at step), the first virtual storage node 410A may process the access request. This is illustrated in step 716. Once the access request is processed, the process 700 continues by returning an access response. This is illustrated at step 718.

It can be seen from the above description that, with the process for storage virtualization as shown in FIG. 5 and FIG. 7, in the case of single-point-of-failure of the virtual storage node, the block storage(s) attached to the unavailable virtual storage node(s) can be dynamically redistributed to other available virtual storage node(s), thereby avoiding the out-of-service of the storage system and achieving 100% storage utility with high availability. Since the storage access can be shared among the virtual storage nodes, it is not necessary to establish data duplicates for the respective virtual storage nodes.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding of the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to those skilled in the art. Therefore, it is intended that the following claims be interpreted as covering all such alterations and modifications as fall within the true spirit and scope of the disclosure.

What is claimed is:

1. A method implemented in a storage system, the storage system comprising a plurality of virtual storage nodes and a plurality of block storages, each of the block storages being attached to a single virtual storage node, the method comprising:
receiving, by one or more processors, an availability for a plurality of virtual storage nodes from at least one virtual storage node;
determining, by the one or more processors and in response to receiving the availability for the plurality of virtual storage nodes, one or more virtual storage nodes of the plurality of virtual storage nodes are unavailable; and
causing, by the one or more processors and in response to determining one or more virtual storage nodes are unavailable, a representative node of the plurality of virtual storage nodes to redistribute one or more block storages attached to the one or more unavailable virtual storage nodes to one or more available virtual storage nodes of the plurality of virtual storage nodes.

2. The method of claim 1, wherein the plurality of virtual storage nodes are configured with address information of the plurality of block storages and meta information, the meta information indicating an attachment relationship of the respective block storages and the respective virtual storage nodes.

3. The method of claim 2, wherein causing the representative node of the plurality of virtual storage nodes to redistribute one or more block storages attached to the one or more unavailable virtual storage nodes to the one or more available virtual storage nodes of the plurality of virtual storage nodes comprises:
causing, by the one or more processors, the representative node to determine a new distribution scheme for redistributing the one or more block storages attached to the one or more unavailable virtual storage nodes to the one or more available virtual storage nodes based on the meta information;
causing, by the one or more processors, the representative node to change attachment relationship of the one or more block storages attached to the one or more unavailable virtual storages according to the new distribution scheme via a block storage management interface of the storage system;
causing, by the one or more processors, the representative node to update the meta information according to the changed attachment relationship; and
causing, by one or more processors, the representative node to send the updated meta information to the one or more available virtual storage nodes.

4. The method of claim 3, wherein causing the representative node to determine a new distribution scheme for redistributing the one or more block storages attached to the one or more unavailable virtual storage nodes to the one or more available virtual storage nodes based on the meta information comprises:
causing, by the one or more processors, the representative node to determine a workload of the one or more available virtual storage nodes based on the meta information; and
causing, by the one or more processors, the representative node to determine the new distribution scheme based on the workload.

5. The method of claim 1, further comprising:
causing, by the one or more processors, the representative node to redistribute at least one block storage of the storage system to recovered one or more virtual storage nodes in response to recovery of one or more unavailable virtual storage nodes.

6. The method of claim 2, further comprising:
causing, by the one or more processors, a first virtual storage node of the plurality of virtual storage nodes to determine a target block storage based on an access request and the address information of the plurality of block storages in response to the first virtual storage node receiving the access request;
causing, by the one or more processors, the first virtual storage node to determine a target virtual storage node to which the target block storage is attached based on the meta information;
causing, by the one or more processors and in response to the target virtual storage node not being the first virtual storage node, the first virtual storage node to forward the access request to the target virtual storage node; and
causing, by the one or more processors, the first virtual storage node to return an access response in response to the first virtual storage node receiving the access response from the target virtual storage node.

7. The method of claim 6, further comprising:
causing, by the one or more processors and in response to the target virtual storage being the first virtual storage node, the first virtual storage node to process the access request; and
causing, by the one or more processors, the first virtual storage node to return an access response.

8. A storage system comprising a plurality of virtual storage nodes and a plurality of block storages, each of the block storages being attached to a single virtual storage node, the storage system further comprising:
one or more processors;
a memory coupled to the one or more processors; and
a set of computer program instructions stored in the memory and executed by the one or more processors to implement a method comprising:
receiving an availability for a plurality of virtual storage nodes from at least one virtual storage node;
determining, in response to receiving the availability for the plurality of virtual storage nodes, one or more virtual storage nodes of the plurality of virtual storage nodes are unavailable; and
causing, in response to determining one or more virtual storage nodes are unavailable, a representative node of the plurality of virtual storage nodes to redistribute one or more block storages attached to the one or more unavailable virtual storage nodes to one or more available virtual storage nodes of the plurality of virtual storage nodes.

9. The storage system of claim 8, wherein the plurality of virtual storage nodes are configured with address information of the plurality of block storages and meta information, the meta information indicating an attachment relationship of the respective block storages and the respective virtual storage nodes.

10. The storage system of claim 9, wherein the causing the representative node of the plurality of virtual storage nodes to redistribute one or more block storages attached to the one or more unavailable virtual storage nodes to the one or more available virtual storage nodes of the plurality of virtual storage nodes comprises:
causing the representative node to determine a new distribution scheme for redistributing the one or more block storages attached to the one or more unavailable virtual storage nodes to the one or more available virtual storage nodes based on the meta information;
causing the representative node to change attachment relationship of the one or more block storages attached to the one or more unavailable virtual storages according to the new distribution scheme via a block storage management interface of the storage system;
causing the representative node to update the meta information according to the changed attachment relationship; and
causing the representative node to send the updated meta information to the one or more available virtual storage nodes.

11. The storage system of claim 10, wherein the causing the representative node to determine a new distribution scheme for redistributing the one or more block storages attached to the one or more unavailable virtual storage nodes to the one or more available virtual storage nodes based on the meta information comprises:
causing the representative node to determine a workload of the one or more available virtual storage nodes based on the meta information; and
causing the representative node to determine the new distribution scheme based on the workload.

12. The storage system of claim 8, wherein the method further comprises:
causing the representative node to redistribute at least one block storage of the storage system to recovered one or more virtual storage nodes in response to the recovery of one or more unavailable virtual storage nodes.

13. The storage system of claim 9, wherein the method further comprises:
causing a first virtual storage node of the plurality of virtual storage nodes to determine a target block storage based on an access request and the address information of the plurality of block storages in response to the first virtual storage node receiving the access request;
causing the first virtual storage node to determine a target virtual storage node to which the target block storage is attached based on the meta information;
causing, in response to the target virtual storage node being not the first virtual storage node, the first virtual storage node to forward the access request to the target virtual storage node; and
causing the first virtual storage node to return an access response in response to the first virtual storage node receiving the access response from the target virtual storage node.

14. The storage system of claim 13, wherein the method further comprises:
causing, in response to the target virtual storage being the first virtual storage node, the first virtual storage node to process the access request; and
causing the first virtual storage node to return an access response.

15. A computer program product implemented in a storage system, the storage system comprising a plurality of virtual storage nodes and a plurality of block storages, each of the block storages being attached to a single virtual storage node, wherein the computer program product comprises a computer readable storage medium having program instructions embodied therewith, wherein the program instructions are executable by processor to implement a method comprising:
receiving an availability for a plurality of virtual storage nodes from at least one virtual storage node;
determining, in response to receiving the availability for the plurality of virtual storage nodes, one or more virtual storage nodes of the plurality of virtual storage nodes are unavailable; and
causing, in response to determining one or more virtual storage nodes are unavailable, a representative node of the plurality of virtual storage nodes to redistribute one or more block storages attached to the one or more unavailable virtual storage nodes to one or more available virtual storage nodes of the plurality of virtual storage nodes.

16. The computer program product of claim 15, wherein the plurality of virtual storage nodes are configured with address information of the plurality of block storages and meta information, the meta information indicating an attachment relationship of the respective block storages and the respective virtual storage nodes.

17. The computer program product of claim 16, wherein the causing the representative node of the plurality of virtual storage nodes to redistribute one or more block storages attached to the one or more unavailable virtual storage nodes to the one or more available virtual storage nodes of the plurality of virtual storage nodes comprises:
causing the representative node to determine a new distribution scheme for redistributing the one or more block storages attached to the one or more unavailable virtual storage nodes to the one or more available virtual storage nodes based on the meta information;
causing the representative node to change attachment relationship of the one or more block storages attached to the one or more unavailable virtual storages according to the new distribution scheme via a block storage management interface of the storage system;
causing the representative node to update the meta information according to the changed attachment relationship; and
causing the representative node to send the updated meta information to the one or more available virtual storage nodes.

18. The computer program product of claim 17, wherein the causing the representative node to determine a new distribution scheme for redistributing the one or more block storages attached to the one or more unavailable virtual storage nodes to the one or more available virtual storage nodes based on the meta information comprises:
causing the representative node to determine a workload of the one or more available virtual storage nodes based on the meta information; and
causing the representative node to determine the new distribution scheme based on the workload.

19. The computer program product of claim 15, wherein the method further comprises:
causing the representative node to redistribute at least one block storage of the storage system to recovered one or more virtual storage nodes in response to the recovery of one or more unavailable virtual storage nodes.

20. The computer program product of claim 16, wherein the method further comprises:
causing a first virtual storage node of the plurality of virtual storage nodes to determine a target block storage based on an access request and the address information of the plurality of block storages in response to the first virtual storage node receiving the access request;
causing the first virtual storage node to determine a target virtual storage node to which the target block storage is attached based on the meta information;
causing, in response to the target virtual storage node being not the first virtual storage node, the first virtual storage node to forward the access request to the target virtual storage node; and
causing the first virtual storage node to return an access response in response to the first virtual storage node receiving the access response from the target virtual storage node.
